(19) United States
(12) Patent Application Publication
(10) Pub. No.: US 2009/0247706 A1
(43) Pub. Date: Oct. 1, 2009

(54) Continuous extrusion process for producing grafted polymers

(76) Inventors: Rayner Krista, Strathroy (CA); John Joseph Decair, Odessa, TX (US); James Nicholas Fowler, Odessa, TX (US); Michael T. Gallagher, Medina, OH (US); John Lovegrove, Sarnia (CA); Shrikant V. Phadke, Odessa, TX (US)

Correspondence Address: LANXESS CORPORATION, 111 RIDC PARK WEST DRIVE, PITTSBURGH, PA, 15275-1112, US

(21) Appl. No.: 11/664,453

(22) PCT Filed: Jan. 31, 2005
(86) PCT No.: PCT/CA05/00119

§ 371 Date: Feb. 27, 2009

Related U.S. Application Data
(60) Provisional application No. 60/617,548, filed on Oct. 11, 2004.

(51) Int. Cl. C08F 255/00; B29C 47/10; B01J 19/00

(52) U.S. Cl. 525/285; 264/211; 422/131

(57) ABSTRACT

A continuous extrusion process for the functionalization of polymers through reactive extrusion. The process uses a continuous extrusion reactor comprising at least two sequential, very closely-coupled, independently driven screw extruders having a total effective length to diameter ratio greater than 60 to 1 and as high as 112 to 1 and providing greatly extended reaction times for efficiently producing a grafted polymer having a high level of functionalization. Drying of the polymer feed is performed in the continuous extrusion reactor. Multiple injections of reactants may be provided. Shear modification of the molecular weight of the grafted polymer is performed in the continuous extrusion reactor after the functionalization reactions. A continuous extrusion reactor and a grafted polymer having a high level of functionalization are also disclosed.

### FIELD OF THE INVENTION

The invention relates to a continuous process for the production of low molecular eight functionalized polymers, for example functionalized ethylene-propylene rubbers (EP-R), through reactive extrusion. The process is useful in the rheological modification of polymers and particularly useful in the production of grafted EP rubbers having a desired rheology.

### BACKGROUND OF THE INVENTION

Functionalized polymers are used as dispersants in lubricating oils to prevent build up of combustion by-products and reduce hydrocarbon emissions. Oil additives need to be shear stable, have a low molecular weight and be low in cost. One example of an oil additive is the grafted polymer ethylene-propylene grafted maleic anhydride (EP-g-MAH). Conventionally, oil additives such as EP-g-MAH are produced in solution based processes conducted in batch reactors. However, in order to improve the economics of the process, it is desirable to produce EP-g-MAH in a continuous extrusion process.

Extruders are used in the continuous production of EP-g-MAH. However, the EP-g-MAH produced in these reactors typically exhibits low levels of MAH grafting (typically 1% or less) and is used as an impact modifier for polyamides, not as an oil additive.

Extruders are also used in reducing the molecular weight of non-functionalized polymers used, for example, as viscosity index modifiers in lubricating oils. The number average molecular weight (Mn), weight average molecular weight (Mw) and polydispersity (Mw/Mn) are all controlled within a final product target range through shear induced molecular weight reduction of the polymer. An extruder providing a high degree of shear through both its internal screw geometry and screw shaft rotational speed is used to reduce the molecular weight of the polymer.

In many applications extruders are used to dry a polymer to remove residual moisture therefrom. Drying extruders utilize high shear rates, which promote polymer heating, to enhance desorption of the water as a vapour under vacuum. Polymers are preferably dried prior to functionalization using maleic anhydride in the production of EP-g-MAH.

While extruders are used in all of the above applications, extruders are not typically combined in continuous processes for the production of low molecular weight EP-g-MAH, particularly EP-g-MAH for use as a low molecular weight dispersant in oil additive applications. In creating a continuous extrusion process for production of EP-g-MAH, there are several practical limitations that must be addressed.

In order to achieve sufficient residence time to perform the various process steps, an extremely long extruder would be required. As the length of an extruder increases, the torque required to rotate the extruder's screw shaft also increases. There is a limit to the torque that may be practically applied without causing damage to the screw shaft. In extruders having a screw geometry suitable for use in the foregoing process, the maximum length to diameter (L/D) ratio before reaching the torque limit is typically about 45:1. This extruder length is simply too short to provide the required residence time for satisfactory completion of all of the process operations in a single extruder. Furthermore, the range of shear conditions employed in the process is preferably achieved through both screw design and variation of screw rotational speed. A single screw shaft does not permit the wide range of shear conditions in the various process stages to be readily achieved.

By connecting two or more extruders in series a continuous extrusion reactor can be made having the desired residence time and having the desired range of shear conditions. However, to permit removal of the screw shafts for maintenance purposes the two extruders are preferably positioned in an L-shaped arrangement. The connection of two extruders in an L-shaped arrangement is accomplished using a transition apparatus.

However, in using a continuous extrusion reactor, a number of previously unrealized process limitations become apparent. These limitations must be overcome in order to achieve the desired continuous extrusion process.

U.S. Pat. No. 3,862,265 (Steinkamp, et al.) discloses an extrusion reaction process for producing functional group grafted polymers such as EP-g-MAH. The reactor employs a single injection zone to separately inject a monomer and a free-radical initiator, followed by a reaction zone that employs shear induced mixing to uniformly distribute the reactants in the polymer. Shear modification of the grafted polymer in the reaction zone is also disclosed. However, since the application of shear causes the polymer temperature to go up, and since the half-life of free-radical initiators such as peroxide decrease rapidly with increasing temperature, employing shear in the reaction zone reduces the reaction efficiency and leads to a low overall level of functionalization in the grafted polymer. It is therefore impractical to achieve high levels of functionalization and molecular weight reduction using this process.

U.S. Pat. No. 5,651,927 (Auda, et al.) discloses an extrusion reaction process for producing a grafted polymer. The process employs multiple injections of different reactants in an effort to conduct two different types of functionalization reactions in a single extrusion vessel. A second objective of the process is to reduce impurities such as unreacted monomers in the final product, thereby obviating the need for further downstream processing. A key feature of the process is venting of unreacted reactants after each injection and prior to the next subsequent injection. The venting operations undesirably limit the maximum level of grafting that can be achieved, as the venting operations take up valuable reactor length (and associated residence time) and prevent unreacted reactants from participating in functionalization reactions in downstream reaction zones. High levels of functionalization are not achieved. In addition, shear induced molecular weight reduction is not disclosed. This process is therefore not suitable for achieving high levels of functionalization and molecular weight reduction in a single continuous extrusion reactor.

The need therefore still exists for a continuous extrusion reaction process for producing low molecular weight functionalized polymers.

### SUMMARY OF THE INVENTION

According to an aspect of the invention, there is provided a process for producing a grafted polymer comprising: providing a thermoplastic polymer having a weight average molecular weight (Mw) of at least 150,000 in a continuous extrusion reactor comprising at least a first extruder and a second extruder connected in series, the continuous extrusion reactor having a length to diameter ratio of at least 60:1; drying the polymer to a moisture content of less than 0.1% in the continuous extrusion reactor; providing the polymer at a temperature of less than 160° C. and a moisture content of less than 0.1% to a first injection zone of the continuous extrusion reactor, the first injection zone located in either the first or second extruder; in the first injection zone, providing a first set of reactants comprising a functionalizing compound and a free-radical initiator; reacting the first set of reactants with the polymer in the continuous extrusion reactor to produce a grafted polymer; and, applying shear to the grafted polymer in the continuous extrusion reactor, the shear sufficient to reduce the weight average molecular weight (Mw) of the grafted polymer by a factor of at least 2.

According to another aspect of the invention, there is provided a grafted polymer produced according to the foregoing process, wherein the functionalizing compound is maleic anhydride, the polymer is ethylene-propylene rubber, the grafted polymer has a weight average molecular weight (Mw) of less than 150,000 and a bound maleic anhydride content of between 1.0 and 5.0 wt %.

According to yet another aspect of the invention, there is provided a continuous extrusion reactor for producing a grafted polymer, the continuous extrusion reactor comprising: a first and second extruder connected in series via a transition apparatus, the continuous extrusion reactor having a length to diameter ratio of at least 60:1; a feed zone for receiving a feed of a polymer to be functionalized; a drying zone for drying the polymer to 0.1 wt % or less; a transition zone located within the transition apparatus; a first injection zone for receiving a first set of reactants comprising a functionalizing compound and a free-radical initiator, the first reaction zone located in either the first or second extruder; a reaction zone downstream of the injection zone for reacting the first set of reactants with the polymer to produce a grafted polymer; and, a shear modification zone downstream of the reaction zone for reducing a weight average molecular weight (Mw) of the grafted polymer by a factor of at least 2.

The polymer may comprise an olefinic polymer of ethylene, such as an olefinic polymer of ethylene and at least one C₃-C₁₀ alpha-mono-olefin. The polymer may comprise a thermoplastic elastomer. The thermoplastic elastomer may further comprise an olefinic ter-polymer containing a diene. Preferably, the polymer is a thermoplastic elastomer that is a polymer of ethylene and propylene, for example ethylene-propylene rubber (EP-R). The ethylene/propylene weight ratio is preferably between 35-65% ethylene, with the balance propylene, more preferably 40-55% ethylene with the balance propylene, still more preferably about 47% ethylene with the balance propylene. The polymer may be provided in any suitable form, such as bales, powders, pellets, agglomerated pellets, etc. The polymer preferably has a Mooney viscosity of 10 (ML 1+4 @ 125° C.) or more and a weight average molecular weight of at least 150,000. More preferably, the polymer has a weight average molecular weight of at least 300,000, even more preferably about 450,000.

The continuous extrusion reactor may comprise two or more extruders connected in series. Each extruder may comprise a plurality of barrel sections. For example, in one embodiment each extruder comprises eleven barrel sections. Each extruder has an internal geometry comprising at least one shaft having flights mounted thereon with a certain shape and pitch as is known in the art. The internal geometry of the extruders need not be the same and preferably the internal geometries of the extruders are different. In a preferred embodiment, both extruders are co-rotating intermeshing twin screw extruders. The geometry of each extruder varies along its length to create different “zones” within the extruder. The geometry is varied according to desired process conditions, such as temperature, degree of shear, polymer residence time, etc. In addition to changes in internal geometry, the rotational speed of the shaft or shafts may be varied to achieve the desired process conditions. For example, in one embodiment the rotational speeds in the first and second extruders are varied to create a polymer residence time in the first extruder that is 70% of the polymer residence time in the second extruder.

A single extruder is typically limited to a maximum length to diameter ratio (L/D) of about 45:1 due to drive torque limitations. By connecting the extruders in series, a much greater L/D can be achieved overall. The length to diameter ratio of the continuous extrusion reactor is greater than 60:1, preferably greater than 85:1, more preferably between 85:1 and 112:1. In addition, the extruders may be operated at different rotational speeds, which permits a greater operational freedom to alter process conditions than is provided by changes in internal geometry alone. Preferably, the extruders are connected in an L-shaped arrangement using a transition apparatus. Advantages of connecting the extruders in an L-shaped arrangement is ease of maintenance, particularly when pulling shafts from the extruder, and reduced footprint. An example of a continuous extrusion reactor is provided in the co-pending United States patent application entitled “A Multiple Extruder Assembly and Process for Continuous Reactive Extrusion”, which is hereby incorporated herein by reference for jurisdictions that permit this method.

The transition apparatus permits polymer to move continuously from the first extruder to the second extruder. The transition apparatus is used in a manner that accommodates differences in thermal expansion between the extruders. The transition apparatus contains a transition zone of the continuous extrusion reactor, which has the benefit of increasing the overall residence time of the reactor. Also, the transition apparatus provides a convenient place for obtaining a measurement of the polymer temperature, which is difficult to do in the extruder itself.

The high length to diameter ratio permits a number of process operations to be performed in a single continuous extrusion reactor. The high L/D also permits a plurality of injection zones to be located in the continuous extrusion reactor, providing additional residence time for any un-reacted reactants to be utilized in downstream injection and reaction zones. This provides a higher overall process efficiency and permits higher levels of functionalization to be achieved. In furtherance of the foregoing, when two or more injection zones are present at least one reactant from the first set of reactants may be provided to the second injection zone. Any volatile un-reacted reactants are preferably only removed from the continuous extrusion reactor at the end of the process, after reaction of the final set of injected reactants with the polymer.

The rubber fed into the continuous extrusion reactor typically carries moisture that is preferably removed prior to functionalization. The drying zone of the continuous extrusion reactor is generally located in the first extruder. The drying zone utilizes a screw geometry that subjects the polymer to a moderate degree of shear, thereby raising the polymer temperature and allowing residual moisture to desorb as water vapour. Although any suitable method may be used to remove residual moisture, the preferred method is to apply externally supplied heat and a vacuum, both of which serve to enhance the rate of water vapour desorption. The polymer is dried in the continuous extrusion reactor to less than 0.1% moisture by weight, preferably less than 0.05% moisture, more preferably less than 0.01% moisture.

After drying, the polymer is still typically quite hot. Shear conditions during drying should be selected so that the polymer exits the drying zone at a temperature not greater than 160° C. The polymer preferably enters the first injection zone at a temperature of less than 160° C., preferably less than 135° C., more preferably less than 125° C. High polymer temperatures lead to un-desirable thermal decomposition of the free-radical initiator, reducing the efficacy of the functionalization reaction. A low polymer temperature upon introduction to the injection zone also advantageously improves the overall level of functionalization.

The first injection zone may be located in either the first extruder or the second extruder. In one embodiment, the first injection zone is located in the first extruder. The geometry of the screw in the injection zone and/or the screw speed is selected to promote shear mixing between the first set of reactants and the polymer. Any number of injection points may be provided in the injection zone, and the injections may occur continuously. The functionalizing compound and the free radical initiator are preferably injected separately at discrete spaced apart intervals along the length of the injection zone. Preferably, the functionalizing compound is injected at least one barrel diameter before the free-radical initiator. This permits some mixing of the functionalization compound with the polymer before injection of the free-radical initiator. The reactants and the polymer are preferably rapidly mixed to prevent undesirable peroxide decomposition. It is generally desirable that the injection zone promotes homogeneity between the polymer and reactants.

The first set of reactants comprises a functionalizing compound. Preferably, the functionalizing compound comprises maleic anhydride, maleic acid, citraconic anhydride, itaconic anhydride, glutaconic anhydride, chloromaleic anhydride, methyl maleic anhydride, acrylic acid, metacrylic acid, fumaric acid, maleimide, maleamic acid, lower alkyl esters of such acids, or combinations thereof. In a preferred embodiment, the functionalizing compound is maleic anhydride.

The first set of reactants further comprises a free-radical initiator. The free radical initiator may comprise an organic peroxide that is thermally stable at moderately high temperatures but decomposes rapidly at temperatures above about 160° C. The free-radical initiator may comprise diacyl peroxides, dialkyl peroxides, or a combination thereof. Preferably, the free radical initiator comprises 2,5-Dimethyl-2,5-di-(t-Butylperoxy)hexane, Di-t-Butyl peroxide, 2,5-Dimethyl-2,5-di-(t-Butylperoxy)hexyne-3, or a combination thereof. In a preferred embodiment, the free radical initiator is 2,5-Dimethyl-2,5-di-(t-Butylperoxy)hexane. The free-radical initiator may be injected as a mixture that comprises up to 50% mineral oil, in a manner that is known in the industry.

The barrel temperatures do not necessarily reflect the polymer temperatures. Barrel temperatures are easier to measure than polymer temperatures and may be used for process control purposes. Each extruder may include both heating means and cooling means so that the barrel temperature may be controlled to a setpoint value in each zone. The choice of setpoint value depends upon the desired polymer temperature and the desired shear conditions within the zone (eg: cool barrel temperatures result in more shear imparted to the polymer at the extruder wall). The actual polymer temperature in any particular zone is a function of: the temperature of the polymer coming into the zone; the extruder barrel temperature in the zone; viscous heating due to shear in the zone; and, (to a lesser extent) the heat of the exothermic grafting reaction in the zone, if applicable.

After sufficient mixing of the reactants and polymer, the temperature is raised through application of shear to accelerate the rate of the grafting reaction in the reaction zone. Reaction may occur in the injection zone as well as in the reaction zone. The reaction zone is designed to provide sufficient residence time for reaction to take place. In one embodiment, a first reaction zone is located in the first extruder immediately following the first injection zone. This desirably permits the transition zone between the first and second extruders to be used for additional residence time as the polymer and reactants pass through to the second extruder.

A second injection zone may be located after the first injection zone and is preferably located in the second extruder. The polymer material provided to the second injection zone may comprise the polymer, the grafted polymer, or a combination thereof. In a preferred embodiment, the first injection zone is followed by a first reaction zone that yields a grafted polymer with a small number of MAH functional groups per polymer chain; this grafted polymer is then provided to the second injection zone, which is followed by a second reaction zone that yields a grafted polymer with a higher level of functionalization due to a larger number of MAH functional groups per polymer chain. The polymer material is provided to the second injection zone at a temperature of less than 190° C., preferably less than 175° C., more preferably less than 165° C. Similar considerations for temperature exist for the second injection zone (and each subsequent injection zone, if present) as for the first injection zone. The second set of reactants is discretely injected in much the same manner as in the first injection zone and mixed with the polymer. A second reaction zone may follow the second injection zone and provides sufficient residence time to permit reaction between the polymer and the reactants from the second set of reactants, along with any un-reacted reactants from the first set of reactants.

The functionalizing compound or the free radical initiator need not be the same in the first and second sets of reactants, although preferably they are the same. In a preferred embodiment, both the first and second sets of reactants comprise a functionalizing compound, preferably maleic anhydride, and a free radical initiator, preferably 2,5-Dimethyl-2,5-di-(t-Butylperoxy)hexane.

Following each injection and reaction zone, the level of grafting in the grafted polymer desirably increases. In a preferred embodiment, the grafted polymer comprises maleic anhydride grafted ethylene-propylene rubber (MAH-g-EPR or EPR-g-MAH). The maleic anhydride content of the grafted polymer may be between 1.0 wt % and 5.0 wt %, preferably between 2.0 wt % and 5.0 wt %, more preferably between 2.2 and 5.0 wt %, still more preferably between 2.5 and 5.0 wt %, even more preferably between 3.0 and 5.0 wt %.

In certain embodiments of this invention, the grafting efficiency of the monomer with the polymer is advantageously improved as compared with prior art grafting processes. For example, the grafting efficiency may be between 50% and 90%, as compared with less than 40% grafting efficiency in prior art grafting processes. Grafting efficiency may be calculated by taking the weight percentage of bound functionalizing compound in the grafted polymer and dividing it by the ratio of the functionalizing compound feed rate to the grafted polymer production rate.

It is desirable that the grafted polymer possess an average molecular weight and a molecular weight distribution selected according to the intended end use. For example, one end use of grafted polymers produced according to the present invention is in oil additive applications. In these applications, a weight average molecular weight (Mw) of between 20,000 and 250,000 and a number average molecular weight of 10,000 to 100,000 is often desirable. A narrow molecular weight distribution, or polydispersity, (expressed as Mw/Mn) in the range of 1 to 3 is also desirable. Controlled thermal degradation of the grafted polymer promotes chain scission and may be used to alter the molecular weight of the grafted polymer. In the present invention, controlled thermal degradation is accomplished by viscous heating and is referred to as shear modification. Shear modification of the grafted polymer is performed to reduce the average molecular weight of the grafted polymer and/or the molecular weight distribution thereof.

Shear modification is conducted under high-shear mixing conditions achieved through a combination of screw geometry and shaft rotational speed. In the present invention, because two or more extruders are connected in series, shear modification may be performed within the continuous extrusion reactor in a shear modification zone thereof. Since the high degree of shear employed during shear modification results in high polymer temperatures (extruder barrel temperature typically greater than 230° C.), and since it is desirable to provide the polymer to the injection zone at a temperature of less than 160° C. to mitigate thermal decomposition of the free-radical initiator, in the process of the present invention shear modification is advantageously performed after the functionalization reactions take place. Performing shear modification after functionalization avoids what would otherwise be impractical process cooling requirements. Accordingly, in the continuous extrusion reactor of the present invention, the shear modification zone is preferably located downstream of the final reaction zone.

The geometry and residence time of the shear modification zone is selected in order to provide the desired grafted polymer rheology according to the intended end use application, as described above. In one embodiment, the shear modification zone is provided to reduce the weight average molecular weight of the grafted polymer by a factor of between 2 and 10, preferably by a factor of between 4 and 9. This results in a measurable change in functionalized polymer rheology.

After the final reaction zone and prior to discharge, the shear modified grafted polymer may be subject to a venting operation wherein volatile residual un-reacted reactants from the first and/or second sets of reactants are removed to enhance final product purity. By-products of the grafting reaction may also be removed in this operation. The volatile reactants are preferably removed under reduced pressure while the grafted polymer is hot, near the end of the extruder, in a venting zone. The venting zone is preferably located after the shear modification zone to take advantage of high polymer temperatures. It should be noted that in the process of the present invention, since the grafting efficiency is typically higher than in conventional extrusion reaction processes, the amount of un-reacted residual reactants is relatively low. A melt seal may be employed between the recovery zone and the final reaction zone to prevent inadvertent escape of reactants from the reaction zone.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a schematic representation of a first embodiment of the process of the present invention;

FIG. 2 is a schematic representation of a second embodiment of the process of the present invention;

FIG. 3 is a schematic representation of a third embodiment of the process of the present invention;

FIG. 4 is a schematic representation of a fourth embodiment of the process of the present invention;

FIG. 5 is a schematic representation of an embodiment of the process of the present invention; and,

FIG. 6 is a plan view showing a continuous extrusion reactor according to the third embodiment of the process of the present invention.

### DESCRIPTION OF PREFERRED EMBODIMENTS

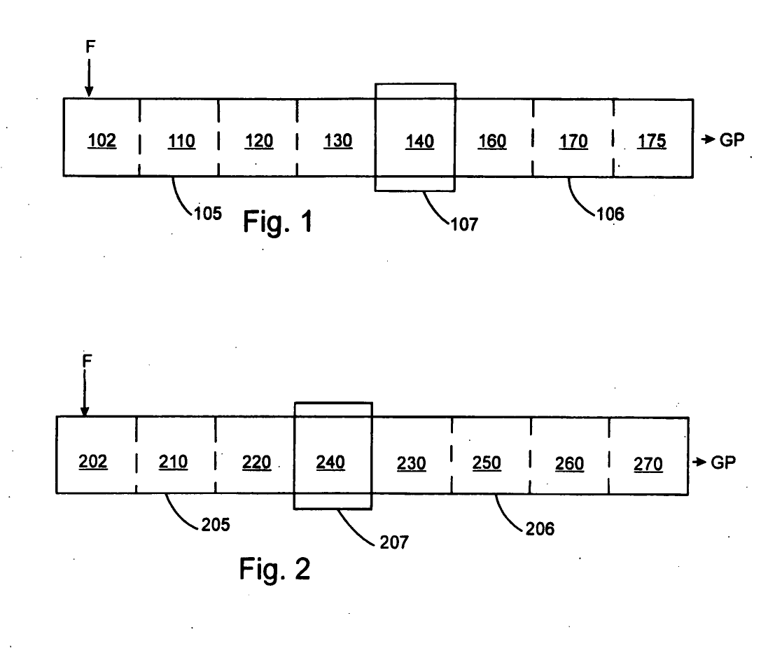

Referring to FIG. 1, a first embodiment of the process of the present invention comprises a continuous extrusion reactor. The continuous extrusion reactor comprises two extruders, each containing a pair of fully intermeshing co-rotating extrusion screws. The continuous extrusion reactor has a L/D of at least 60:1. Polymer F comprising ethylene-propylene rubber (EP-R) is fed into the first extruder 105 and enters into a feed zone 102. In the initial heating zone 110, energy is applied to the polymer to reduce its apparent viscosity. The energy is provided as externally supplied heat delivered through resistance heating, elements on the exterior of the continuous extrusion reactor around the initial heating zone 110 and in the form of mechanical work supplied by the rotating screw, which has a geometry selected to provide a moderate degree of shear. Next, the polymer passes into a drying zone 120 of the continuous extrusion reactor, where a vacuum is applied. The polymer exiting the drying zone has a moisture content of less than 0.1%.

Shear imparted during the drying zone 120 is controlled so that the polymer enters the first injection zone 130 with a temperature of less than 160° C. A first set of reactants comprising liquid maleic anhydride and the free-radical initiator 2,5-Dimethyl-2,5-di-(t-Butylperoxy)hexane is injected into the first injection zone 130. Two sets of injectors are used to separately inject first the functionalization compound in a first set of injectors and then the free-radical initiator in a second set of injectors. The first and second sets of injectors in the first injection zone are spaced apart along the length of the extruder by approximately 1 barrel diameter. This allows the functionalization compound time to mix with the polymer prior to injection of the free-radical initiator. The injection zone 130 provides mixing to the polymer to uniformly distribute the first set of reactants. The polymer mixed with the first set of reactants then passes into the transition zone 140, located in transition apparatus 107.

The reaction zone 160, which is located in the second extruder 106 provides increased temperature to accelerate the rate of reaction and is designed to provide sufficient residence time (about 10-20 seconds) to permit the grafting reaction to take place to a practical extent. A grafted polymer comprising EPR-g-MAH is produced in the reaction zone 160 that has a quantity of maleic anhydride between 1.0 and 5.0 wt %.

The molecular weight of the grafted polymer exiting the reaction zone 160 is typically greater than 150,000. In order to reduce this molecular weight and provide the desired rheology, the grafted polymer enters a shear modification zone 170 of the continuous extrusion reactor. In this zone, the polymer is subjected to shear in order to reduce its molecular weight by a factor of between 2 and 10. Due to the high degree of shear, the barrel temperature in the shear modification zone 170 is typically at least 230° C.

The hot grafted polymer next enters a venting zone 175, where an applied vacuum is used to remove volatile un-reacted reactants, etc. The grafted polymer GP exiting the reactor is cooled and subjected to final processing before being packaged in a manner suitable for the intended end-use application.

Referring to FIG. 2, a second embodiment of the process of the present invention comprises a continuous extrusion reactor. The continuous extrusion reactor comprises two extruders, each containing a pair of fully intermeshing co-rotating extrusion screws. The continuous extrusion reactor has a L/D of at least 60:1. Polymer F comprising ethylene-propylene rubber (EP-R) is fed into the first extruder 205 and enters into a feed zone 202. In the initial heating zone 210, energy is applied to the polymer to reduce its apparent viscosity. The energy is provided as externally supplied heat delivered through resistance heating elements on the exterior of the continuous extrusion reactor around the initial heating zone 210 and in the form of mechanical work supplied by the rotating screw, which has a geometry selected to provide a moderate degree of shear. Next, the polymer passes into a drying zone 220 of the continuous extrusion reactor, where a vacuum is applied to remove moisture. The polymer exiting the drying zone has a moisture content of less than 0.1%.

Shear imparted during the drying zone 220 is controlled so that the polymer enters the transition zone 240, located in transition apparatus 207, with a temperature of less than 160° C. The polymer then enters the second extruder 206.

In the second extruder 206, the polymer enters the first injection zone 230. A first set of reactants comprising liquid maleic anhydride and the free-radical initiator 2,5-Dimethyl-2,5-di-(t-Butylperoxy)hexane is injected into the first injection zone 230. Two sets of injectors are used to separately inject first the functionalization compound in a first set of injectors and then the free-radical initiator in a second set of injectors. The first and second sets of injectors in the first injection zone are spaced apart along the length of the extruder by approximately 1 barrel diameter. This allows the functionalization compound time to mix with the polymer prior to injection of the free-radical initiator. The first injection zone 230 provides mixing to the polymer to uniformly distribute the first set of reactants. The polymer mixed with the first set of reactants then passes into the second injection zone 250.

In the second injection zone 250, a second set of reactants comprising liquid maleic anhydride and the free-radical initiator 2,5-Dimethyl-2,5-di-(t-Butylperoxy)hexane is injected into the polymer containing the first set of reactants and is mixed therewith. The reaction zone 260 provides increased temperature to accelerate the rate of reaction and is designed to provide sufficient residence time (about 10-20 seconds) to permit the grafting reaction to take place to a practical extent. A grafted polymer comprising EPR-g-MAH is produced in the reaction zone 260 that has a quantity of maleic anhydride between 1.0 and 5.0 wt %.

The molecular weight of the grafted polymer exiting the reaction zone 260 is typically greater than 150,000. In order to reduce this molecular weight and provide the desired rheology, the grafted polymer enters a shear modification zone 270 of the continuous extrusion reactor. In this zone, the polymer is subjected to shear in order to reduce its molecular weight by a factor of between 2 and 10. Due to the high degree of shear, the barrel temperature in the shear modification zone 270 is typically at least 230° C. A vacuum may be applied at the end of the shear zone 270 to remove volatile unreacted reactants, etc. The hot grafted polymer GP exiting the reactor is cooled and subjected to final processing before being packaged in a manner suitable for the intended end-use application.

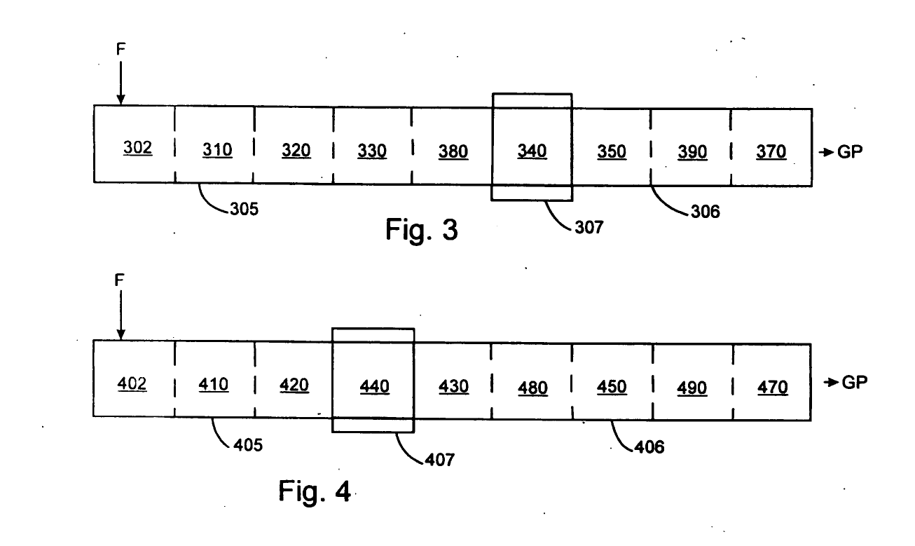

Referring to FIG. 3, a third embodiment of the process of the present invention comprises a continuous extrusion reactor. The continuous extrusion reactor comprises two extruders, each containing a pair of fully intermeshing co-rotating extrusion screws. The continuous extrusion reactor has a L/D of at least 60:1. Polymer F comprising ethylene-propylene rubber (EP-R) is fed into the first extruder 305 and enters into a feed zone 302. In the initial heating zone 310, energy is applied to the polymer to reduce its apparent viscosity. The energy is provided as externally supplied heat delivered through resistance heating elements on the exterior of the continuous extrusion reactor around the initial heating zone 310 and in the form of mechanical work supplied by the rotating screw, which has a geometry selected to provide a high degree of shear. Next, the polymer passes into a drying zone 320 of the continuous extrusion reactor, where a vacuum is applied to remove moisture. The polymer exiting the drying zone has a moisture content of less than 0.1%.

Shear imparted during the drying zone 320 is controlled so that the polymer enters the first injection zone 330 with a temperature of less than 160° C. A first set of reactants comprising liquid maleic anhydride and the free-radical initiator 2,5-Dimethyl-2,5-di-(t-Butylperoxy)hexane is injected into the first injection zone 330. Two sets of injectors are used to separately inject first the functionalization compound in a first set of injectors and then the free-radical initiator in a second set of injectors. The first and second sets of injectors in the first injection zone are spaced apart along the length of the extruder by approximately 1 barrel diameter. This allows the functionalization compound time to mix with the polymer prior to injection of the free-radical initiator. The first injection zone 330 provides mixing to the polymer to uniformly distribute the first set of reactants.

The first reaction zone 380 provides increased temperature to accelerate the rate of reaction and is designed to provide sufficient residence time (about 10-20 seconds) to permit the grafting reaction to take place to a practical extent. The polymer and reactants begin to react and pass from the first reaction zone 380 into the transition zone 340, located in transition apparatus 307, where the reaction is permitted to continue. The transition zone 340 therefore serves to extend the overall reaction time of the first set of reactants with the polymer and thereby advantageously increases the conversion and the efficiency of utilization of the reactants. A grafted polymer comprising EPR-g-MAH is produced. The mixed polymer material (comprising grafted polymer and any unreacted reactants from the first set of reactants) passes from the transition zone 340 into the second extruder 306.

The polymer material enters the second injection zone 350 at a temperature less than 190° C. In the second injection zone 350, a second set of reactants comprising liquid maleic anhydride and the free-radical initiator 2,5-Dimethyl-2,5-di-(t-Butylperoxy)hexane is injected and is mixed with the polymer material. Two sets of injectors are used to separately inject first the functionalization compound in a first set of injectors and then the free-radical initiator in a second set of injectors as previously described with reference to the first injection zone 330. The second injection zone 350 provides mixing to the polymer material as an aid in uniformly distributing the second set of reactants. The second reaction zone 390 provides increased temperature to accelerate the rate of reaction and is designed to provide sufficient residence time (about 10-20 seconds) to permit the grafting reaction to take place to a practical extent. The grafted polymer comprising EPR-g-MAH exiting the second reaction zone 390 has a higher level of functionalization than the grafted polymer exiting the first reaction zone 380. The total quantity of grafted maleic anhydride is between about 1.0 and 5.0 wt %.

The molecular weight of the grafted polymer exiting the second reaction zone 390 is typically at least 150,000. In order to reduce this molecular weight and provide the desired rheology, the grafted polymer enters a shear modification zone 370 of the continuous extrusion reactor. In this zone, the grafted polymer is subjected to shear in order to reduce its molecular weight by a factor of between 2 and 10. Due to the shear provided, the barrel temperature in the shear modification zone 370 is typically at least 230° C. A vacuum may be applied at the end of the shear modification zone 370 to remove volatile unreacted reactants, etc. The hot grafted polymer GP exiting the reactor is cooled and subjected to final processing before being packaged in a manner suitable for the intended end-use application.

It will be understood by persons skilled in the art that the foregoing describes a preferred embodiment of the process where in the functionalizing compounds in the first and second sets of reactants are the same. When the functionalizing compounds in the first and second sets of reactants are different, a first grafted polymer exits the first reaction zone 380 that is different from a second grafted polymer exiting from the second reaction zone 390. In this case, the second grafted polymer contains functional groups derived from both the first and second functionalizing compounds.

Referring to FIG. 4, a fourth embodiment of the process of the present invention comprises a continuous extrusion reactor. The continuous extrusion reactor comprises two extruders, each containing a pair of fully intermeshing co-rotating extrusion screws. The continuous extrusion reactor has a L/D of at least 60:1. Polymer F comprising ethylene-propylene rubber (EP-R) is fed into the first extruder 405 and enters into a feed zone 402. In the initial heating zone 410, energy is applied to the polymer to reduce its apparent viscosity. The energy is provided as externally supplied heat delivered through resistance heating elements on the exterior of the continuous extrusion reactor around the initial heating zone 410 and in the form of mechanical work supplied by the rotating screw, which has a geometry selected to provide a moderate degree of shear. Next, the polymer passes into a drying zone 420 of the continuous extrusion reactor, where a vacuum is applied to remove moisture. The polymer exiting the drying zone has a moisture content of less than 0.1%.

Shear imparted during the drying zone 420 is controlled so that the polymer enters the transition zone 440, located in transition apparatus 407 with a temperature of less than 160° C. The polymer then enters the second extruder 406.

In the second extruder 406, the polymer enters the first injection zone 430. A first set of reactants comprising liquid maleic anhydride and the free-radical initiator 2,5-Dimethyl-2,5-di-(t-Butylperoxy)hexane is injected into the first injection zone 430. Two sets of injectors are used to separately inject first the functionalization compound in a first set of injectors and then the free-radical initiator in a second set of injectors. The first and second sets of injectors in the first injection zone are spaced apart along the length of the extruder by approximately 1 barrel diameter. This allows the functionalization compound time to mix with the polymer prior to injection of the free-radical initiator. The first injection zone 430 provides mixing to the polymer to uniformly distribute the first set of reactants.

The first reaction zone 480 provides increased temperature to accelerate the rate of reaction and is designed to provide sufficient residence time (about 10-20 seconds) to permit the grafting reaction to take place to a practical extent. A grafted polymer comprising EPR-g-MAH is produced. The mixed polymer material (containing grafted polymer and any unreacted reactants from the first set of reactants) then passes into the second injection zone 450.

The polymer material enters the second injection zone 450 at a temperature of less than 190° C. In the second injection zone 450, a second set of reactants comprising liquid maleic anhydride and the free-radical initiator 2,5-Dimethyl-2,5-di-(t-Butylperoxy)hexane is injected and mixed with the polymer material. Two sets of injectors are used to separately inject first the functionalization compound in a first set of injectors and then the free-radical initiator in a second set of injectors as previously described with reference to the first injection zone 430. The second injection zone 450 provides mixing to the polymer material to uniformly distribute the second set of reactants. The second reaction zone 490 provides increased temperature to accelerate the rate of reaction and is designed to provide sufficient residence time (about 10-20 seconds) to permit the functionalization reaction to take place to a practical extent. The grafted polymer comprising EPR-g-MAH exiting the second reaction zone 490 has a higher level of functionalization than the grafted polymer exiting the first reaction zone 480. The total quantity of grafted maleic anhydride is between about 1.0 and 5.0 wt %.

The molecular weight of the grafted polymer exiting the second reaction zone 490 is typically at least 150,000. In order to reduce this molecular weight and provide the desired rheology, the grafted polymer enters a shear modification zone 470 of the continuous extrusion reactor. In this zone, the grafted polymer is subjected to shear in order to reduce its molecular weight by a factor of between 2 and 10. Due to the shear provided, the barrel temperature in the shear modification zone 470 is typically at least 230° C. A vacuum may be applied at the end of the shear modification zone 470 to remove volatile unreacted reactants, etc. The hot grafted polymer GP exiting the reactor is cooled and subjected to final processing before being packaged in a manner suitable for the intended end-use application.

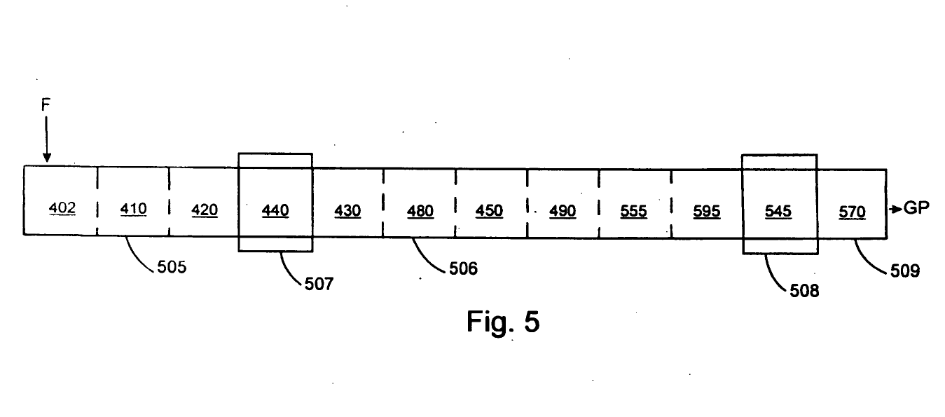

Referring to FIG. 5, a fifth embodiment of the process of the present invention comprises a continuous extrusion reactor that is comprised of three extruders 505, 506, 509 connected in series via two transition zones 507, 508. The fifth embodiment is similar to the fourth embodiment up to the end of the second reaction zone 490. After exiting the second reaction zone 490, the polymer mixture (containing the grafted polymer from the first and second reaction zones and any un-reacted reactants from the first and second sets of reactants) enters a third injection zone 555. In the third injection zone 555, a third set of reactants comprising liquid maleic anhydride and the free-radical initiator 2,5-Dimethyl-2,5-di-(t-Butylperoxy)hexane is injected and subjected to shear induced mixing. Two sets of injectors are used to separately inject first the functionalization compound in a first set of injectors and then the free-radical initiator in a second set of injectors as previously described with reference to the first injection zone 430 of the fourth embodiment. The third injection zone 555 provides shear mixing to the polymer material to uniformly distribute the third set of reactants.

The third reaction zone 595 provides increased temperature to accelerate the rate of reaction and is designed to provide sufficient residence time (about 10-20 seconds) to permit the grafting reaction to take place to a practical extent. The polymer material passes from the third reaction zone 595 into the second transition zone 545, where the reaction is permitted to continue. The second transition zone 545 therefore serves to extend the overall reaction time of the reactants with the polymer material and thereby advantageously increases the conversion and the efficiency of utilization of the reactants. The grafted polymer comprising EPR-g-MAH exiting the third reaction zone 595 has a higher level of functionalization than the grafted polymer exiting the second reaction zone 490. The total quantity of grafted maleic anhydride is between about 1.0 and 5.0 wt %. The grafted polymer passes from the second transition zone 545 into the third extruder 509.

The molecular weight of the grafted polymer exiting the third reaction zone 595 is typically at least 150,000. In order to reduce this molecular weight and provide the desired rheology, the grafted polymer enters a shear modification zone 570 of the continuous extrusion reactor. In this zone, the grafted polymer is subjected to shear in order to reduce its molecular weight by a factor of between 2 and 10. Due to the high degree of shear provided, the barrel temperature in the shear modification zone 570 is typically at least 230° C. A vacuum may be applied at the end of the shear modification zone 570 to remove volatile unreacted reactants, etc. The hot grafted polymer GP exiting the reactor is cooled and subjected to final processing before being packaged in a manner suitable for the intended end-use application.

By separating the drying operation into a first extruder, the injection and reaction operations into a second extruder, and the shear modification into a third extruder, a screw shaft rotational speed may be selected in each extruder that provides the desired combination of shear and residence time. Having three extruders advantageously improves the overall flexibility of the process.

In all of the foregoing embodiments, a separate vent zone (as described in FIG. 1 at 175) may be added following the shear modification zone. The vent zone permits un-reacted residual components of the first, second, or third sets of reactants to be vented while the polymer is hot, after shear modification. The venting operation typically occurs under reduced pressure. In cases where the grafting efficiency is sufficiently high, there may be a negligible quantity of unreacted components and accordingly the vent zone may be omitted entirely.

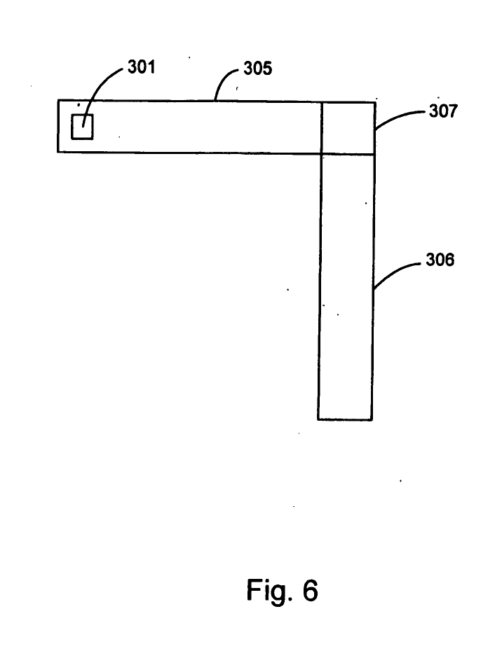

Referring to FIG. 6, a continuous extrusion reactor 300 according to the third embodiment of the process according to the present invention is shown in plan view. The first extruder 305 has a feed opening 301 and is connected to the second extruder 306 by a transition assembly 307 that houses the transition zone 340 (not shown in FIG. 6) of the process. Various features, such as sampling ports, electric motors, control systems, final processing operations, polymer feeding systems, volatile recovery lines, vacuum lines, maintenance and inspection hatches, safety relief systems, process control instrumentation, etc. have been omitted for clarity. The overall reactor configuration is L-shaped as seen in plan view. This permits ready maintenance and removal of the screw assemblies from each reactor and provides for convenient placement of the motors needed to power the screws.

The invention may be more clearly understood with reference to the following examples.

### Experimental Protocol

The following experimental protocol was followed in all of the Examples.

Two extruders (Century, 92 mm twin screw, 11 barrel sections) were connected in series via a transition apparatus to form a continuous extrusion reactor. Each extruder had an L/D ratio of about 43:1 and a variable geometry screw. The screw was adjusted according to the experimental objectives to add or remove processing zones and to modify the shear and residence time conditions in each zone. The continuous extrusion reactor thus formed had an overall L/D of about 88:1, including the transition apparatus.

A polymer comprising ethylene-propylene rubber (LANXESS, Buna EP T VP KA 8930) was fed through a feed chute directly into the polymer heating zone of the first extruder. Liquid maleic anhydride (CAS# 108-31-6) was injected through injector nozzles into the injection zone of the continuous extrusion reactor. The organic peroxide 2,5-Dimethyl-2,5-di(t-Butylperoxy)hexane (Atofina, Luperox® 101, CAS# 78-63-7) diluted in a 1:1 ratio with mineral oil (Drakeol, CAS# 8042-47-5) was injected about one barrel diameter after the maleic anhydride.

A minimum of twenty minutes was allowed for the process to stabilize and reach steady state conditions before sampling. Samples were obtained from the continuous extruder reactor discharge. In the case of the lowest molecular weight materials (Examples 2 and 4), samples were collected on a metal plate and quenched with water before testing. For each experiment, the following tests were performed:

TABLE 1
Experimental methods

| Test | Method |
|---|---|
| Polymer composition | ASTM 3900 (FTIR) |
| Molecular weight (Mw) | HTGPC in 140° C. 1, 2, 4 |
| | Tri-chlorobenzene |
| | calibrated with a broad |
| | polystyrene standard |
| Bound Maleic Anhydride | FTIR |
| Melt Flow Index | ASTM D1238 |

### Example 1

### Comparative

In order to examine the effect of shear on the grafted polymer and to explore the efficacy of molecular weight reduction after grafting, a single extruder was used with two separate passes. In the first pass, the polymer was dried and the molecular weight was reduced somewhat. The product was boxed in 50 pound individual boxes. In the second pass, the 50 pound boxes of dried polymer were re-processed in the extruder to reduce molecular weight through shear modification followed by functionalization of the polymer by maleic anhydride grafting. The process zones provided in each extruder pass and the corresponding operational conditions are provided in Table 2. Since the amount of shear provided in a given process zone is difficult to quantify, the term “relative shear” qualitatively describes the shear applied in a given process zone relative to the highest shear zone, which has a relative shear value of 1. To permit comparison between Examples, the standard for highest shear zone is selected taking into consideration the extruder configurations used in all experiments.

TABLE 2
Process zones and operational conditions for Example 1

| | Extruder | | | | |
|---|---|---|---|---|---|
| | Pass # 1 | Extruder Pass # 2 | | | |
| | Drying | Injection | Reaction | Shear | |
| | Zone | Zone | Zone | Zone | Vent Zone |
| Relative | 0.5 | 0.2 | 0.2 | 0.5 | 0.5 |
| Shear | | | | | |
| Extruder | 200 | 150 | 150 | 200 | 200 |
| Barrel | | | | | |
| Temp. | | | | | |
| (° C.) | | | | | |
| MAH | — | 5 | — | — | — |
| (phr) | | | | | |
| Peroxide | — | 0.9 | — | — | — |
| (phr) | | | | | |

The grafted polymer produced using the above process conditions had the following characteristics:

TABLE 3
Characteristics of grafted polymer produced in Example 1

| | |
|---|---|
| Bound Maleic Anhydride (wt %) | 1.8 |
| (FTIR Method) | |
| Melt Flow Index (g/10 min) | 14 |
| (test conditions: 190° C., 5.2 kg) | |
| Number Average Molecular Weight (Mn) | 47,000 |
| (High Temp. GPC, Polystyrene standard) | |
| Weight Average Molecular Weight (Mw) | 121,000 |
| Polydispersity (Mw/Mn) | 2.57 |

Although reasonable final product characteristics were obtained, the process was impractical in that the costly steps of feed preparation, packaging and handling had to be performed twice.

### Example 2

### Comparative

The effect of performing molecular weight reduction through shear modification before grafting the polymer was investigated in a continuous extrusion reactor comprising two extruders connected in series. The intent of this experiment was to explore the feasibility of combining molecular weight reduction and grafting in a single continuous extrusion reactor. The process zones provided in each extruder and the corresponding operational conditions are provided in Table 4.

TABLE 4
Process zones and operational conditions for Example 2

| | Extruder # 1 | | | Extruder # 2 | | |
|---|---|---|---|---|---|---|
| | Drying | Shear | Transition | Injection | Reaction | Vent |
| | Zone | Zone | Zone | Zone | Zone | Zone |
| Relative | 1 | 1 | 0.1 | 0.3 | 0.3 | 1 |
| Shear | | | | | | |
| Extruder | 300 | 300 | 260 | 200 | 200 | 200 |
| Barrel | | | | | | |
| Temp. | | | | | | |
| (° C.) | | | | | | |
| MAH | — | — | — | 5 | — | — |
| (phr) | | | | | | |
| Peroxide | — | — | — | 0.9 | — | — |
| (phr) | | | | | | |

The grafted polymer produced using the above process conditions had the following characteristics:

TABLE 5
Characteristics of grafted polymer produced in Example 2

| | |
|---|---|
| Bound Maleic Anhydride (wt %) | 0 |
| (FTIR Method) | |
| Melt Flow Index (g/10 min) | 384 |
| (test conditions: 190° C., 5.2 kg) | |
| Number Average Molecular Weight (Mn) | 29,000 |
| (High Temp. GPC, Polystyrene standard) | |
| Weight Average Molecular Weight (Mw) | 76,000 |
| Polydispersity (Mw/Mn) | 2.62 |

Example 2 shows that no measurable grafting was accomplished when the polymer was first sheared to reduce its molecular weight then functionalized. One proposed explanation for this is that the high polymer temperatures (approximately 300° C.) produced in the shear modification zone result in a dramatic decrease in the peroxide half-life in the injection and reaction zones, which effectively prevents the grafting reaction from taking place.

### Example 3

### Invention

A process according to the fourth embodiment (as shown in FIG. 4) was operated. The process zones provided in each extruder and the corresponding operational conditions are provided in Table 6.

TABLE 6
Process zones and operational conditions for Example 3

| | Ex- | | | | | | | |
|---|---|---|---|---|---|---|---|---|
| | truder | | Extruder # 2 | | | | | |
| | # 1 | Tran- | 1^{st} | 1^{st} | 2^{nd} | 2^{nd} | | |
| | Drying | sition | Inj. | R'xn | Inj. | R'xn | Shear | Vent |
| | Zone | Zone | Zone | Zone | Zone | Zone | Zone | Zone |
| Relative | 0.5 | 0.1 | 0.3 | 0.3 | 0.3 | 0.3 | 1 | 1 |
| Shear | | | | | | | | |
| Extruder | 230 | 150 | 150 | 150 | 200 | 200 | 200 | 200 |
| Barrel | | | | | | | | |
| Temp. | | | | | | | | |
| (° C.) | | | | | | | | |
| MAH | — | — | 1.5 | — | 2.3 | — | — | — |
| (phr) | | | | | | | | |
| Peroxide | — | — | 0.3 | — | 0.45 | — | — | — |
| (phr) | | | | | | | | |

The grafted polymer produced using the above process conditions had the following characteristics:

TABLE 7
Characteristics of grafted polymer produced in Example 3

| | |
|---|---|
| Bound Maleic Anhydride (wt %) | 2.0 |
| (FTIR Method) | |
| Melt Flow Index (g/10 min) | 20 |
| (test conditions: 190° C., 5.2 kg) | |
| Number Average Molecular Weight (Mn) | 55,000 |
| (High Temp. GPC, Polystyrene standard) | |
| Weight Average Molecular Weight (Mw) | 125,000 |
| Polydispersity (Mw/Mn) | 2.27 |

Example 3 shows that a process according to the fourth embodiment can be used to produce a commercially useful product. By drying the polymer in the first extruder, coupling the first extruder to a second extruder using a transition apparatus, and employing two reactant injections in the second extruder, a high overall level of bound maleic anhydride is produced and sufficient extruder space remains in the second extruder to accomplish a moderate level (about threefold) reduction of molecular weight of the grafted polymer through shearing.

### Example 4

### Invention

The process according to the third embodiment (shown in FIG. 3) was operated. It was surmised that, by conducting the first injection in the first extruder and utilizing the transition zone for additional reaction residence time, a grafted polymer with a higher maleic anhydride level could be produced with a greater overall efficiency of utilization of reactants. The process zones provided in each extruder and the corresponding operational conditions are provided in Table 8.

TABLE 8
Process zones and operational conditions for Example 4

| | Extruder # 1 | | | | Extruder # 2 | | | |
|---|---|---|---|---|---|---|---|---|
| | | | 1^{st} | | | 2^{nd} | | |
| | Drying | 1^{st} Inj. | R'xn | Transition | 2^{nd} Inj. | R'xn | Shear | Vent |
| | Zone | Zone | Zone | Zone | Zone | Zone | Zone | Zone |
| Relative | 0.5 | 0.3 | 0.3 | 0.1 | 0.3 | 0.3 | 1 | 1 |
| Shear | | | | | | | | |
| Extruder | 200 | 110 | 170 | 150 | 150 | 150 | 270 | 270 |
| Barrel | | | | | | | | |
| Temp. | | | | | | | | |
| (° C.) | | | | | | | | |
| MAH | — | 2.0 | — | — | 2.0 | — | — | — |
| (phr) | | | | | | | | |
| Peroxide | — | 0.35 | — | — | 0.35 | — | — | — |
| (phr) | | | | | | | | |

The grafted polymer produced using the above process conditions had the following characteristics:

TABLE 9
Characteristics of grafted polymer produced in Example 4

| | |
|---|---|
| Bound Maleic Anhydride (wt %) | 2.2 |
| (FTIR Method) | |
| Melt Flow Index (g/10 min) | 200 |
| (test conditions: 190° C., 5.2 kg) | |
| Number Average Molecular Weight (Mn) | 20,000 |
| (High Temp. GPC, Polystyrene standard) | |
| Weight Average Molecular Weight (Mw) | 55,000 |
| Polydispersity (Mw/Mn) | 2.75 |

Example 4 shows that, by moving the first reactant injection to the first extruder and by utilizing the transition zone to provide additional reactor residence time, a high overall level of bound maleic anhydride is produced and sufficient extruder space remains in the second extruder to accomplish a high level (about nine fold) reduction of molecular weight of the grafted polymer through shear.

Other advantages which are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A process for producing a grafted polymer comprising:
a) providing a thermoplastic polymer having a weight average molecular weight (Mw) of at least 150,000 in a continuous extrusion reactor comprising at least a first extruder and a second extruder connected in series, the continuous extrusion reactor having a length to diameter ratio of at least 60:1;
b) drying the polymer to a moisture content of less than 0.1% in the continuous extrusion reactor;
c) providing the polymer at a temperature of less than 160° C. and a moisture content of less than 0.1% to a first injection zone of the continuous extrusion reactor, the first injection zone located in either the first or second extruder;
d) in the first injection zone, providing a first set of reactants comprising a first functionalizing compound and a first free-radical initiator;
e) reacting the first set of reactants with the polymer in the continuous extrusion reactor to produce a grafted polymer; and,
f) applying shear to the grafted polymer in the continuous extrusion reactor, the shear sufficient to reduce the weight average molecular weight (Mw) of the grafted polymer by a factor of at least 2.

2. A process according to claim 1, wherein the process further comprises providing a grafted polymer at a temperature of less than 190° C. and a moisture content of less than 0.1% to a second injection zone of the continuous extrusion reactor.

3. A process according to claim 2, wherein the second injection zone is located in the second extruder.

4. A process according to claims 2 or 3, wherein at least one reactant from the first set of reactants is provided to the second injection zone.

5. A process according to any one of claims 2 to 4, wherein the process further comprises providing a second set of reactants comprising a second free-radical initiator and a second functionalizing compound in the second injection zone.

6. A process according to claim 5, wherein the second functionalizing compound is the same as the first functionalizing compound.

7. A process according to claim 5, wherein the second free-radical initiator is the same as the first free-radical initiator.

8. A process according to any one of claims 5 to 7, wherein the process further comprises reacting the second set of reactants with the grafted polymer.

9. A process according to claim 6, wherein the second free-radical initiator is the same as the first free-radical initiator.

10. A process according to claim 9, wherein the process further comprises reacting the second set of reactants with the grafted polymer to thereby increase the level of functionalization of the grafted polymer.

11. A process according to claim 8, wherein the grafted polymer is mixed with volatile un-reacted reactants, and wherein the volatile un-reacted reactants are only removed from the continuous extrusion reactor after reacting the second set of reactants with the polymer material.

12. A process according to any one of claims 2 to 11, wherein between about 1.5 and 2.5 phr of the functionalizing compound is introduced into the second injection zone.

13. A process according to any one of claims 2 to 12, wherein between about 0.25 and 0.50 phr of the free-radical initiator is introduced into the second injection zone.

14. A process according to any one of claims 1 to 13, wherein between about 1.5 and 2.5 phr of the functionalizing compound is introduced into the first injection zone.

15. A process according to any one of claims 1 to 14, wherein between about 0.25 and 0.50 phr of the free-radical initiator is introduced into the first injection zone.

16. A process according to any one of claims 1 to 15, wherein the length to diameter ratio is at least 85:1

17. A process according to any one of claims 1 to 16, wherein the polymer is a thermoplastic elastomer.

18. A process according to any one of claims 1 to 17, wherein the polymer is an olefinic polymer of ethylene.

19. A process according to any one of claims 1 to 18, wherein the polymer is an olefinic polymer of ethylene and at least one C₃-C₁₀ alpha-mono-olefin.

20. A process according to any one of claims 1 to 19, wherein the polymer is ethylene-propylene rubber.

21. A process according to any one of claims 1 to 20, wherein the polymer is dried to a moisture content of less than 0.05%.

22. A process according to any one of claims 1 to 21, wherein the polymer is provided to the first injection zone at a temperature of less than 125° C.

23. A process according to any one of claims 1 to 22, wherein the functionalizing compound is a carboxylic acid or a carboxylic acid anhydride.

24. A process according to any one of claims 1 to 23, wherein the functionalizing compound comprises maleic anhydride, maleic acid, citraconic anhydride, itaconic anhydride, glutaconic anhydride, chloromaleic anhydride, methyl maleic anhydride, acrylic acid, metacrylic acid, fumaric acid, maleimide, maleamic acid, lower alkyl esters of such acids, or a combination thereof.

25. A process according to any one of claims 1 to 24, wherein the functionalizing compound is maleic anhydride.

26. A process according to claim 25, wherein the grafted polymer contains between 1.0 and 5.0 wt % bound maleic anhydride.

27. A process according to claim 26, wherein the grafted polymer contains between 2.2 and 5.0 wt % bound maleic anhydride.

28. A process according to any one of claims 1 to 27, wherein the free-radical initiator comprises 2,5-Dimethyl-2,5-di-(t-Butylperoxy)hexane, Di-t-Butyl peroxide, 2,5-Dimethyl-2,5-di-(t-Butylperoxy) hexyne-3, or a combination thereof.

29. A process according to any one of claims 1 to 28, wherein there are two extruders.

30. A process according to any one of claims 1 to 29, wherein each extruder has a shaft having a shaft torque and a shaft rotational speed, and wherein the shaft torques and shaft rotational speeds are different in the first and second extruders.

31. A process according to any one of claims 1 to 30, wherein each extruder has a polymer residence time and wherein the polymer residence times are different in the first and second extruders.

32. A process according to any one of claims 1 to 31, wherein the grafted polymer is mixed with volatile un-reacted reactants, and wherein the process further comprises venting un-reacted reactants in the continuous extrusion reactor after step f).

33. A grafted polymer produced according to the process of any one of claims 1 to 32, wherein the functionalization compound is maleic anhydride, the polymer is ethylene-propylene rubber, the grafted polymer has a weight average molecular weight (Mw) of less than 150,000 and a bound maleic anhydride content of between 1.0 and 5.0 wt %.

34. A continuous extrusion reactor for producing a grafted polymer, the continuous extrusion reactor comprising:
a) a first and second extruder connected in series via a transition apparatus, the continuous extrusion reactor having a length to diameter ratio of at least 60:1;
b) a feed zone for receiving a feed of a polymer to be functionalized;
c) a drying zone for drying the polymer to 0.1 wt % or less;
d) a transition zone located within the transition apparatus;
e) a first injection zone for receiving a first set of reactants comprising a first functionalizing compound and a first free-radical initiator, the first injection zone located in either the first or second extruder;
f) a reaction zone downstream of the injection zone for reacting the first set of reactants with the polymer to produce a grafted polymer; and,
g) a shear modification zone downstream of the reaction zone for reducing a weight average molecular weight (Mw) of the grafted polymer by a factor of at least 2.

35. A continuous extrusion reactor according to claim 34, wherein the continuous extrusion reactor further comprises a vent zone downstream of the shear modification zone for venting an un-reacted reactant from the grafted polymer.
